(19) United States
(12) Patent Application Publication
(10) Pub. No.: US 2013/0063671 A1
(43) Pub. Date: Mar. 14, 2013

(54) COMPACT ILLUMINATOR

(71) Applicants: Zhisheng Yun, Woodbury, MN (US); Andrew J. Ouderkirk, Saint Paul, MN (US); Kim Leong Tan, Singapore (SG); Andrew T. Tio, Singapore (SG)

(72) Inventors: Zhisheng Yun, Woodbury, MN (US); Andrew J. Ouderkirk, Saint Paul, MN (US); Kim Leong Tan, Singapore (SG); Andrew T. Tio, Singapore (SG)

(73) Assignee: 3M INNOVATIVE PROPERTIES COMPANY, ST. PAUL, MN (US)

(21) Appl. No.: 13/698,089

(22) PCT Filed: May 18, 2011
(86) PCT No.: PCT/US2011/036930

§ 371 Date: Nov. 15, 2012

Related U.S. Application Data
(60) Provisional application No. 61/346,193, filed on May 19, 2010.

(51) Int. Cl. G02F 1/1335; G03B 21/14; F21V 9/14; G02B 27/12; G02B 27/28

(52) U.S. Cl. 349/8; 359/622; 359/489.08; 359/623; 362/19; 353/20

(57) ABSTRACT

The present disclosure relates generally to an optical element, a light projector that includes the optical element, and an image projector that includes the optical element. In particular, the optical element provides an improved uniformity of light by homogenizing the light with lenslet arrays, such as “fly-eye arrays” (FEA). The FEA is positioned to homogenize an unpolarized combined light before the light is converted to a single polarization state.

### RELATED APPLICATIONS

This application is related to the following U.S. patent applications, which are incorporated by reference: “Compact Optical Integrator” U.S. Ser. No. 61/292,574 (Attorney Docket No. 65902US002) filed on Jan. 6, 2010; and also “Polarized Projection Illuminator” (Attorney Docket No. 66249US002) and “Fly Eye Integrator Polarization Converter” (Attorney Docket No. 66247US002), both filed on an even date herewith.

### BACKGROUND

Projection systems used for projecting an image on a screen can use multiple color light sources, such as light emitting diodes (LED's), with different colors to generate the illumination light. Several optical elements are disposed between the LED's and the image display unit to combine and transfer the light from the LED's to the image display unit. The image display unit can use various methods to impose an image on the light. For example, the image display unit may use polarization, as with transmissive or reflective liquid crystal displays.

Still other projection systems used for projecting an image on a screen can use white light configured to imagewise reflect from a digital micro-mirror (DMM) array, such as the array used in Texas Instruments' Digital Light Processor (DLP®) displays. In the DLP® display, individual mirrors within the digital micro-mirror array represent individual pixels of the projected image. A display pixel is illuminated when the corresponding mirror is tilted so that incident light is directed into the projected optical path. A rotating color wheel placed within the optical path is timed to the reflection of light from the digital micro-mirror array, so that the reflected white light is filtered to project the color corresponding to the pixel. The digital micro-mirror array is then switched to the next desired pixel color, and the process is continued at such a rapid rate that the entire projected display appears to be continuously illuminated. The digital micro-mirror projection system requires fewer pixelated array components, which can result in a smaller size projector.

Image brightness is an important parameter of a projection system. The brightness of color light sources and the efficiencies of collecting, combining, homogenizing and delivering the light to the image display unit all affect brightness. As the size of modern projector systems decreases, there is a need to maintain an adequate level of output brightness while at the same time keeping heat produced by the color light sources at a low level that can be dissipated in a small projector system. There is a need for a light combining system that combines multiple color lights with increased efficiency to provide a light output with an adequate level of brightness without excessive power consumption by light sources.

Such electronic projectors often include a device for optically homogenizing a beam of light in order to improve brightness and color uniformity for light projected on a screen. Two common devices are an integrating tunnel and a fly's eye homogenizer. Fly's eye homogenizers can be very compact, and for this reason is a commonly used device. Integrating tunnels can be more efficient at homogenization, but a hollow tunnel generally requires a length that is often 5 times the height or width, whichever is greater. Solid tunnels often are longer than hollow tunnels, due to the effects of refraction.

Pico and pocket projectors have limited available space for light integrators or homogenizers. However, efficient and uniform light output from the optical devices used in these projectors (such as color combiners and polarization converters) can require a compact and efficient integrator.

### SUMMARY

The present disclosure relates generally to an optical element, a light projector that includes the optical element, and an image projector that includes the optical element. In particular, the optical element provides an improved uniformity of light by homogenizing the light with lenslet arrays, such as “fly-eye arrays” (FEA). In one aspect, the present disclosure provides an optical element that includes a first lenslet array having a first plurality of lenses disposed to accept an unpolarized light and output a convergent unpolarized light. The optical element further includes a second lenslet array having a second plurality of lenses disposed to accept the convergent unpolarized light and output a divergent unpolarized light. The optical element still further includes a polarization converter disposed to accept the divergent unpolarized light and output a polarized light. The first lenslet array and the second lenslet array are a monolithic array, and an unpolarized light ray coincident with the optical axis of a first lens of the first plurality of lenses is coincident with the optical axis of a second lens of the second plurality of lenses.

In another aspect, the present disclosure provides a light projector that includes a first unpolarized light source and a second unpolarized light source, a color combiner disposed to output a combined unpolarized light from the first unpolarized light source and the second unpolarized light source and an optical element. The optical element includes a first lenslet array having a first plurality of lenses disposed to accept the combined unpolarized light and output a convergent unpolarized light, a second lenslet array having a second plurality of lenses disposed to accept the convergent unpolarized light and output a divergent unpolarized light, and a polarization converter disposed to accept the divergent unpolarized light and output a polarized light. The first lenslet array and the second lenslet array are a monolithic array, and an unpolarized light ray coincident with the optical axis of a first lens of the first plurality of lenses is coincident with the optical axis of a second lens of the second plurality of lenses.

In yet another aspect, the present disclosure provides an image projector that includes a first unpolarized light source and a second unpolarized light source, a color combiner disposed to output a combined unpolarized light from the first unpolarized light source and the second unpolarized light source, an optical element, a spatial light modulator disposed to impart an image to the polarized light, and projection optics. The optical element includes a first lenslet array having a first plurality of lenses disposed to accept the combined unpolarized light and output a convergent unpolarized light, a second lenslet array having a second plurality of lenses disposed to accept the convergent unpolarized light and output a divergent unpolarized light, and a polarization converter disposed to accept the divergent unpolarized light and output a polarized light. The first lenslet array and the second lenslet array are a monolithic array, and an unpolarized light ray coincident with the optical axis of a first lens of the first plurality of lenses is coincident with the optical axis of a second lens of the second plurality of lenses.

The above summary is not intended to describe each disclosed embodiment or every implementation of the present disclosure. The figures and the detailed description below more particularly exemplify illustrative embodiments.

### BRIEF DESCRIPTION OF THE DRAWINGS

Throughout the specification reference is made to the appended drawings, where like reference numerals designate like elements, and wherein:

FIG. 1 shows a schematic diagram of an image projector;

FIG. 2 shows a cross-section schematic of an optical element;

FIG. 3 shows a cross-section schematic of an optical element; and

FIG. 4 shows a cross-section schematic of a polarization converter.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

This disclosure generally relates to image projectors, in particular image projectors improve the uniformity of light by homogenizing the light with lenslet arrays, such as “fly-eye arrays” (FEA). In one particular embodiment, a compact polarized illumination system includes a polarization converting system (PCS) and a molded monolithic Fly-Eye Array (FEA) integrator. Combination of a polarization converter with a monolithic FEA can result in both a high efficiency and good uniformity simultaneously, in a compact system. The FEA integrator includes arrays of convex lenses molded on two opposing surfaces.

LCoS-based portable projection systems are becoming common due to the availability of low cost and high resolution LCoS panels. A list of elements in an LED-illuminated LCoS projector may include LED light source or sources, optional color combiner, optional pre-polarizing system, relay optics, PBS, LCoS panel, and projection lens unit. For LCoS-based projection systems, the efficiency and contrast of the projector is directly linked to the degree of polarization of light entering the PBS. For at least this reason, a pre-polarizing system that either utilizes a reflection/recycling optic or a polarization-conversion optical element is often required.

Polarization conversion schemes utilizing polarizing beam splitters and half-wave retarders are one of the most efficient ways to provide polarized light into the PBS. One challenge with polarization-converted light is that it may suffer from spatial nonuniformity, leading to artifacts in the displayed image. Therefore, in systems with polarization converters, a homogenization system is desirable.

It is common in conventional projection systems that a FEA consisting of a pair of thin glass microlenslet array plates separated by an air gap is used to homogenize the light. In handheld projectors, such a paired FEA system typically has the drawbacks of having greater thickness and more challenging alignment tolerances.

More recently, single-element monolithic molded plastic or glass FEA units have been adopted for very compact projection systems. However, such molded monolithic units typically have maximum birefringence of 50 nm or more and high variation in retardance and optical axis orientation and as such are only used for homogenizing unpolarized light. In some cases, a single monolithic element with low birefringence following a high-efficiency polarization converter can achieve high optical efficiency, good image uniformity, and compact size simultaneously.

In one particular embodiment, an illuminator for an image projector includes a light source in which emitted unpolarized light is directed into a polarization converter. The polarization converter separates the light into two paths, one for each polarization state. The path length for each of the two polarization states is approximately equal, and the polarized beams of light pass through to a monolithic FEA integrator. The monolithic FEA integrator can cause the light beams to diverge, and the light beams are then directed for further processing, for example, by using a spatial light modulator to impart an image to the light beams, and projection optics to display the image on a screen.

In some cases, optical projectors use a non-polarized light source, such as a light emitting diode (LED) or a discharge light, a polarization selecting element, a first polarization spatial modulator, and a second polarization selecting element. Since the first polarization selecting element rejects 50% of the light emitted from the non-polarized light source, polarization-selective projectors can often have a lower efficiency than non-polarized devices.

One technique of increasing the efficiency of polarization-selective projectors is to add a polarization converter between the light source and the first polarization selecting element. Generally, there are two ways of designing a polarization converter used in the art. The first is to partially collimate the light emitting from the light source, pass the partially collimated beam of light through an array of lenses, and position an array of polarization converters at each focal point. The polarization converter typically has a polarizing beam splitter having polarization selective tilted film (for example MacNeille polarizer, a wire grid polarizer, or birefringent optical film polarizer), where the reflected polarization is reflected by a tilted mirror such that the reflected beam propagates parallel to the beam that is transmitted by the tilted polarization selective film. Either one or the other beams of polarized light is passed through half-wave retarders, such that both beams have the same polarization state.

Another technique of converting the unpolarized light beam to a light beam having a single polarization state is to pass the entire beam of light through a tilted polarization selector, and the split beams are conditioned by mirrors and half-wave retarders such that a single polarization state is emitted. Illuminating a polarization selective spatial light modulator directly with a polarization converter can result in luminance non-uniformity and color non-uniformity.

In some cases, the polarization converter can be positioned after the illumination light leaves a fly's eye array (FEA) homogenizing component. In some cases, the polarization converter can be positioned in front of an FEA homogenizing component, such that the illumination light is polarized as it enters the FEA homogenizing component. One drawback of the latter configuration is that the fly's eye array needs to be made birefringence free, or at the least, a very low birefringence. It can be challenging to control the molding fabrication process of the fly's eye array with sufficient precision, in order to produce low birefringence material. A much wider range of materials can be used, for example, higher birefringence materials become acceptable, such as those having a birefringence of about 50 nm or more, when the FEA homogenizing component is placed after the illumination source and before the light is polarized.

Generally, the FEA serves to homogenize the polarized illumination light on the imager plane. Each of the pairs of lenses on opposite surfaces of the FEA spread the light over the imager plane, such that the illumination light is effectively blended. The light bundle sampled by a first lenslet on the first FEA surface is focused by a second lenslet on the second FEA surface. The light is then redistributed subsequent optics to cover the entire imager plane, such as an LCoS imager plane. This process is repeated across the FEA for each of the lenslet pairs, so that even if the light distribution is non-uniform in the front of the FEA, it will be redistributed to form a uniform light distribution on the imager.

In one particular embodiment, a polarization converter can incorporate a fly's eye array to homogenize the light in a projection system. The input side of the polarization converter includes a monolithic FEA to homogenize the light. The input and output side of the monolithic FEA include the same number of lenses, with each lens on the output side centered approximately at the focal point of a matching lens at the input side. The lenses can be cylindrical, bi-convex, spherical, or aspherical; however, in many cases spherical lenses can be preferred. The fly's eye integrator and polarization converter can significantly improve the illuminance and color uniformity of the projector.

The lenses of the monolithic FEA may be fabricated by microreplicating plastic lenses on a first film, which can be cut, aligned, and bonded to microreplicated plastic lenses on a second film. Another alternative is to mold one or both lenslet arrays as single units out of glass or plastic, and bond those together without an intervening film. The lenslet arrays may be made from a single axis lens, such as a cylindrical lens or a lens with two axes of refraction, such as a spherical lens. The number of lenses on each of the input and output surfaces of the monolithic FEA may range from a single lens, a single dimensional array of lenses, to a two dimensional array of lenses. In one particular embodiment, each of the input and output surfaces of the monolithic FEA can include a rectangular array of spherical lenses, such as a square array having a size ranging from a 5×5 array to a 20×20 array or more. Generally, a larger array of lenses can reduce the separation between the arrays, so that the overall size of the projection system can be reduced.

In some cases, a folded fly eye array can homogenize the illuminating light. A folded fly-eye array can be formed with a first lenslet array, a folding mirror, and a second lenslet array, where the lenses making up the second lenslet array are approximately at the focal point of the lenses making up the first lenslet array.

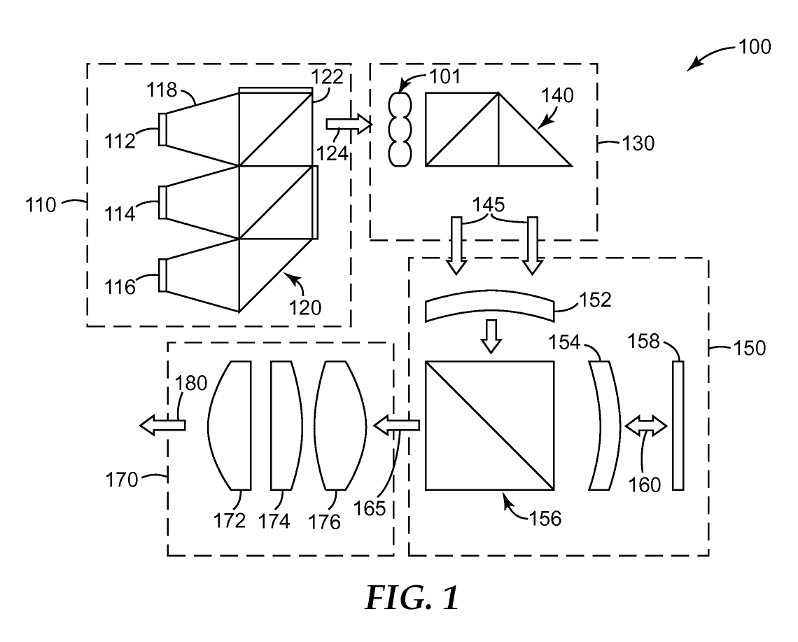

FIG. 1 shows a schematic diagram of an image projector 100, according to one aspect of the disclosure. Image projector 100 includes a color combiner module 110 that is capable of injecting a combined light output 124 into a homogenizing polarization converter module 130 where the combined light output 124 becomes converted to a homogenized polarized light 145 that exits the homogenizing polarization converter module 130 and enters an image generator module 150. The image generator module 150 outputs an imaged light 165 that enters a projection module 170 where the imaged light 165 becomes a projected imaged light 180.

In one aspect, color combiner module 110 includes different wavelength spectrum input light sources 112, 114, and 116 that are input through collimating optics 118 to color combiner 120. The color combiner 120 produces a combined light output 124 that includes the different wavelength spectrum lights. Color combiner modules 110 that are suitable for use in the present disclosure include those described, for example, in PCT Patent Publication Nos. WO2009/085856 entitled “Light Combiner”, WO2009/086310 entitled “Light Combiner”, WO2009/139798 entitled “Optical Element and Color Combiner”, WO2009/139799 entitled “Optical Element and Color Combiner”; and also in co-pending PCT Patent Application Nos. US2009/062939 entitled “Polarization Converting Color Combiner”, US2009/063779 entitled “High Durability Color Combiner”, US2009/064927 entitled “Color Combiner”, and US2009/064931 entitled “Polarization Converting Color Combiner”.

In one aspect, the received inputs light sources 112, 114, 116, are unpolarized, and the combined light output 124 is also unpolarized. The combined light output 124 can be a polychromatic combined light that comprises more than one wavelength spectrum of light. The combined light output 124 can be a time sequenced output of each of the received lights. In one aspect, each of the different wavelength spectra of light corresponds to a different color light (for example red, green and blue), and the combined light output is white light, or a time sequenced red, green and blue light. For purposes of the description provided herein, “color light” and “wavelength spectrum light” are both intended to mean light having a wavelength spectrum range which may be correlated to a specific color if visible to the human eye. The more general term “wavelength spectrum light” refers to both visible and other wavelength spectrums of light including, for example, infrared light.

According to one aspect, each input light source (112, 114, 116) comprises one or more light emitting diodes (LED's). Various light sources can be used such as lasers, laser diodes, organic LED's (OLED's), and non solid state light sources such as ultra high pressure (UHP), halogen or xenon lamps with appropriate collectors or reflectors. Light sources, light collimators, lenses, and light integrators useful in the present invention are further described, for example, in Published U.S. Patent Application No. US 2008/0285129, the disclosure of which is herein included in its entirety.

In one aspect, homogenizing polarization converter module 130 includes a polarization converter 140 that is capable of converting unpolarized combined light output 124 into homogenized polarized light 145. Homogenizing polarization converter module 130 further can include a monolithic array of lenses 101, such as a monolithic FEA of lenses described elsewhere that can homogenize and improve the uniformity of the combined light output 124 that exits the homogenizing polarization converter module 130 as homogenized polarized light 145.

In one aspect, image generator module 150 includes a polarizing beam splitter (PBS) 156, representative imaging optics 152, 154, and a spatial light modulator 158 that cooperate to convert the homogenized polarized light 145 into an imaged light 165.

Suitable spatial light modulators (that is, image generators) have been described previously, for example, in U.S. Pat. Nos. 7,362,507 (Duncan et al.), 7,529,029 (Duncan et al.); in U.S. Publication No. 2008-0285129-A1 (Magarill et al.); and also in PCT Publication No. WO2007/016015 (Duncan et al.). In one particular embodiment, homogenized polarized light 145 is a divergent light originating from each lens of the FEA. After passing through imaging optics 152, 154 and PBS 156, homogenized polarized light 145 becomes imaging light 160 that uniformly illuminates the spatial light modulator. In one particular embodiment, each of the divergent light ray bundles from each of the lenses in the FEA illuminates a major portion of the spatial light modulator 158 so that the individual divergent ray bundles overlap each other.

In one aspect, projection module 170 includes representative projection optics 172, 174, 176, that can be used to project imaged light 165 as projected light 180. Suitable projection optics 172, 174, 176 have been described previously, and are well known to those of skill in the art.

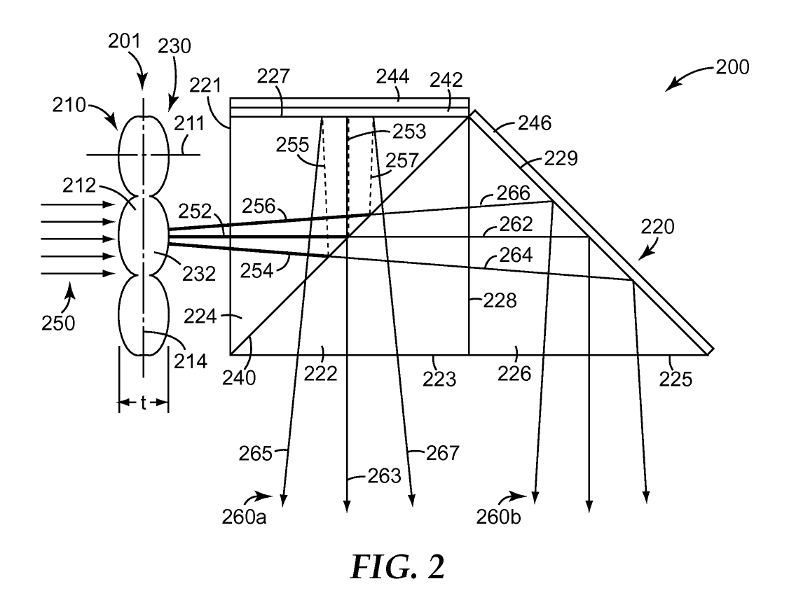

FIG. 2 shows a side-view schematic of an optical element 200, according to one aspect of the disclosure. Optical element 200 can be used as the homogenizing polarization converter module 130 in the image projector 100 as shown in FIG. 1. Optical element 200 includes a first lenslet array 210, a second lenslet array 230, and a polarization converter 220. Each of the first lenslet array 210 and the second lenslet array 230 can be referred to as a “Fly-Eye Array”, or FEA, as known in the art. In some cases, each of the first lenslet array 210 and the second lenslet array 230 can include a converging (that is, positive) power. The first lenslet array 210 and the second lenslet array 230 together form a monolithic FEA 201 that has a thickness “t”, and can include an optional central substrate 214 between first lenslet array 210 and second lenslet array 230. Generally, the thickness “t” can be about 10 mm, about 6 mm, or about 4 mm, or even less than about 4 mm, depending on the overall size of the polarization converter 220. An unpolarized light 250, such as the unpolarized combined light output 124 shown in FIG. 1, enters the monolithic FEA 201, and exits the polarization converter 220 as a first divergent p-polarized light 260b and a second p-polarized light 260a. Generally, the path length of each polarization state of unpolarized light 250 is essentially the same through the optical element 200, as can be seen from the discussion that follows.

The first lenslet array 210 includes a representative first lens 212 of the plurality of lenses disposed to accept the unpolarized light 250 and output a convergent unpolarized light to a second lens 232 of the second lenslet array 230 in the monolithic FEA 201. In some cases, each lens of the first lenslet array 210 can be, for example, a cylindrical lens, and can be arranged in an array such that the long axis of the cylinder is perpendicular to the cross-section shown in FIG. 2. In some cases, each lens of the first lenslet array 210 can be, for example, a spherical lens, and can be arranged in a rectangular array. Each lens of the first lenslet array 210 has a first optical axis 211, and a surface 214 that is typically a planar surface. The first lenslet array 210 can be formed from a glass or a polymer, and can include a substrate coincident with surface 214, or can instead be a monolithic lenslet array formed from a single material.

The second lenslet array 230 includes a representative second lens 232 disposed such that the optical axis 211 of each lens of both the first lenslet array 210 and the second lenslet array 230 are coincident, and the unpolarized light 250 becomes a divergent unpolarized light shown by representative first unpolarized light 252, second unpolarized light 254, and third unpolarized light 256. In some cases, each lens of the second lenslet array 230 can be, for example, a cylindrical lens, and can be arranged in an array such that the long axis of the cylinder is perpendicular to the cross-section shown in FIG. 2. In some cases, each lens of the second lenslet array 230 can be, for example, a spherical lens, and can be arranged in a rectangular array. Each lens of the second lenslet array 230 is aligned to the optical axis 211, and has surface 214 that is typically a planar surface. The second lenslet array 230 can be formed from a glass or a polymer, and can include a substrate coincident with surface 214, or can instead be a monolithic lenslet array formed from a single material. Generally, the focal point of each lens (for example, first lens 212) of the first lenslet array 210 is positioned at the first principle plane of each lens (for example, second lens 232b) of the second lenslet array 230. Generally, both the first lenslet array 210 and the second lenslet array 230 can be formed from a single material to form monolithic FEA 201, as described elsewhere.

In some cases, a high index glass can be used for the lenslet array. Also, high index glasses with lead tend to have low stress optical component (SOC) that can lead to a preferable low-birefringence. However, it can be difficult to mold small lens features into glass. As a result, polymeric materials are preferred for the lenslet array construction, including, for example, such polymers as polycarbonates (PC), cyclo-olefin polymers (COP), cyclo-olefin co-polymers (COC, and polymethylmethacrylates (PMMA). Exemplary polymeric materials include, for example, cyclo-olefinic polymer materials such as Zeonex® (for example, E48R, 330R, 340R, 480R, and the like, available from Zeon Chemicals L.P., Louisville, Ky.); cyclo-olefin co-polymers such as APL5514ML, APL5014DP and the like (available from Mitsui Chemicals, Inc. JP); polymethylmethacrylate (PMMA) materials such as WF100 (available from Mitsubishi Rayon Technologies, JP) and Acrypet® VH001 (available from Guangzhou Hongsu Trading Co., Guangdong, CN); and polycarbonate, polyester, or polyphenylene sulfide materials. Generally, a birefringence of less than 50 nm, or less than 30 nm, or even less than 20 nm can be preferred (at a nominal wavelength of 550 nm). However, a much wider range of materials can be used, for example, higher birefringence materials become acceptable, such as those having a birefringence of about 50 nm or more, when the FEA homogenizing component is placed after the illumination source and before the light is polarized, as described elsewhere.

The polarization converter 220 is disposed to accept the divergent unpolarized light, such as shown by representative first unpolarized light 252, second unpolarized light 254, and third unpolarized light 256, and output a divergent polarized light as described below. Polarization converter 220 includes a first prism 222 having first and second faces 223 and 228, a second prism 224 having third and fourth faces 221 and 227, and a third prism 226 having second face 228 (common with first prism 222), fifth face 225, and diagonal face 229. A reflective polarizer 240 is disposed on the diagonal between first and second prisms 222, 224.

The reflective polarizer 240 can be any known reflective polarizer such as a MacNeille polarizer, a wire grid polarizer, a multilayer optical film polarizer, or a circular polarizer such as a cholesteric liquid crystal polarizer. According to one embodiment, a multilayer optical film polarizer can be a preferred reflective polarizer. Generally, reflective polarizer 240 can be a Cartesian reflective polarizer or a non-Cartesian reflective polarizer. A non-Cartesian reflective polarizer can include multilayer inorganic films such as those produced by sequential deposition of inorganic dielectrics, such as a MacNeille polarizer. A Cartesian reflective polarizer has a polarization axis direction, and includes both wire-grid polarizers and polymeric multilayer optical films such as can be produced by extrusion and subsequent stretching of a multilayer polymeric laminate. In one embodiment, reflective polarizer 240 is aligned so that one polarization axis is parallel to a first polarization direction, and perpendicular to a second polarization direction. In one embodiment, the first polarization direction can be the s-polarization direction, and the second polarization direction can be the p-polarization direction.

A Cartesian reflective polarizer film provides the polarizing beam splitter with an ability to pass input light rays that are not fully collimated, and that are divergent or skewed from a central light beam axis. The Cartesian reflective polarizer film can comprise a polymeric multilayer optical film that comprises multiple layers of dielectric or polymeric material. Use of dielectric films can have the advantage of low attenuation of light and high efficiency in passing light. The multilayer optical film can comprise polymeric multilayer optical films such as those described in U.S. Pat. No. 5,962,114 (Jonza et al.) or U.S. Pat. No. 6,721,096 (Bruzzone et al.).

The polarization converter 220 further includes a polarization rotating reflector that includes a quarter-wave retarder 242 and a broadband mirror 244 disposed on fourth face 227. Polarization rotating reflectors are discussed elsewhere, for example, in PCT Publication No. WO2009/085856 (English et al.). The polarization rotating reflector reverses the propagation direction of the light and alters the magnitude of the polarization components, depending of the components and their orientation in the polarization rotating reflector. The polarization rotating reflector generally includes a reflector and a retarder. In one embodiment, the reflector can be a broadband mirror that blocks the transmission of light by reflection. The retarder can provide any desired retardation, such as an eighth-wave retarder, a quarter-wave retarder, and the like. In embodiments described herein, there can be an advantage to using a quarter-wave retarder and an associated reflector. Linearly polarized light is changed to circularly polarized light as it passes through a quarter-wave retarder aligned at an angle of 45° to the axis of light polarization. Reflections from the reflective polarizer and quarter-wave retarder/reflectors result in efficient light output from the polarization converter. In contrast, linearly polarized light is changed to a polarization state partway between s-polarization and p-polarization (either elliptical or linear) as it passes through other retarders and orientations, and can result in a lower efficiency of the polarization converter.

Preferably, quarter-wave retarder 242 includes a quarter-wave polarization direction aligned at +/−45° to the first polarization direction. In some embodiments, the quarter-wave polarization direction can be aligned at any degree orientation to first polarization direction, for example from 90° in a counter-clockwise direction to 90° in a clockwise direction. It can be advantageous to orient the retarder at approximately +/−45° as described, since circularly polarized light results when linearly polarized light passes through a quarter-wave retarder so aligned to the polarization direction. Other orientations of quarter-wave retarders can result in s-polarized light not being fully transformed to p-polarized light, and p-polarized light not being fully transformed to s-polarized light, upon reflection from the mirrors, resulting in reduced efficiency as described elsewhere.

A second broadband mirror 246 is disposed adjacent the diagonal 229 of third prism 226. The components of the polarization converter including prisms, reflective polarizers, quarter-wave retarders, mirrors and any other components can be bonded together by a suitable optical adhesive. The optical adhesive used to bond the components together can have a lower index of refraction than the index of refraction of the prisms used in the light combiner. A polarization converter that is fully bonded together offers advantages including alignment stability during assembly, handling and use.

According to one particular embodiment, the prism faces 221, 223, 225, 227, 229 are polished external surfaces that are in contact with a material having an index of refraction “n₁” that is less than the index of refraction “n₂” of prisms 222, 224, and 226. According to another embodiment, all of the external faces of the polarization converter 220 (including end faces, not shown) are polished faces that provide TIR of oblique light rays within polarization converter 220. The polished external surfaces are in contact with a material having an index of refraction “n₁” that is less than the index of refraction “n₂” of prisms 222, 224, and 226. TIR improves light utilization in polarization converter 220, particularly when the light directed into the polarization converter 220 is not collimated along a central axis, that is the incoming light is either convergent or divergent.

Unpolarized light rays 250 coincident with the first optical axis 211 of the first lens 212 passes through monolithic FEA 201, becomes first divergent unpolarized light ray 252, enters polarization converter 220 through third face 221 of second prism 224, and intercepts reflective polarizer 240 where it is split into first p-polarized divergent light ray 262 and first s-polarized divergent light ray 253. In a similar manner, another of the unpolarized light rays 250 entering first lens 212 at a position separated from the first optical axis 211 passes through monolithic FEA 201, becomes second divergent unpolarized light ray 254, and is split into second p-polarized divergent light ray 264 and second s-polarized divergent light ray 255. In yet another similar manner, another of the unpolarized light rays 250 entering first lens 212 at a second position separated from the first optical axis 211 passes through monolithic FEA 201, becomes third convergent unpolarized light ray 256, and is split into third p-polarized divergent light ray 266 and third s-polarized divergent light ray 257.

First, second, and third p-polarized divergent light rays 262, 264, 266 pass through reflective polarizer 240, reflect from broadband mirror 246, and exit polarization converter 220 through fifth face 225 of third prism 226, and becomes first p-polarized divergent light 260b.

First, second, and third s-polarized divergent light rays 253, 255, 257 reflect from reflective polarizer 240, exit second prism through fourth face 227, change to circular polarized divergent light as they pass through quarter-wave retarder 242, reflect from broadband mirror 244 changing the direction of circular polarization, and become fourth, fifth, and sixth p-polarized divergent light 263, 265, 267, as they pass again through quarter-wave retarder 242. Fourth, fifth, and sixth p-polarized divergent light 263, 265, 267 pass through reflective polarizer 240, exit polarization converter 220 through first face 223 of first prism 222, and become second p-polarized divergent light 260a. Second and first p-polarized divergent light 260a and 260b pass through the remaining portions of the projection system described in FIG. 1, with an improved uniformity.

In some cases, the quarter-wave retarder 242 can instead be disposed adjacent reflective polarizer 240, between broadband mirror 244 and reflective polarizer 240 (not shown), and a similar optical path can be traced through the polarization converter 220, as known to one of skill in the art. In some cases, the polarization rotating reflector that includes the quarter-wave retarder 242 and broadband mirror 244 can instead be disposed on the third face 221, and the unpolarized input light rays 250 can enter polarization converter 220 through fourth face 227, and a similar optical path can be traced through the polarization converter 220, as known to one of skill in the art.

In one particular embodiment, minimizing the amount of birefringent effects that can impact a beam of light traversing a Fly's Eye's Array (FEA) includes selection of an FEA material that has a low stress optical coefficient (SOC), and is thin. The low SOC manifests as low induced birefringence in the substrate of the FEA after both surfaces of the substrate have been structured/molded into matching lenslet arrays. A second aspect to achieving low birefringence is to reduce the optical path in the substrate material. This requires a short focal length design for the lenslets. The focal point of the first lenslet array is cast onto the principal plane of the second lenslet array. The short focal length drives a small radius of curvature for each lenslet element. As a result, the lateral size of each lenslet typically is reduced, in order to maintain the aperture of each lenslet element (that is, no flat region of the array, without power). Therefore, the resultant number of lenslets per array is increased, which can improve beam homogenization.

Having a small lenslet lateral size requires a high precision in the registration of the optical axis of each lenslet element in the first lenslet array to the corresponding lenslet optical axis in the second lenslet array. In one particular embodiment, for example, a FEA used in an LED illuminator can have an approximately 0.6 mm×0.9 mm lenslet aperture and with typical mechanical positional tolerances of 30-50 um, the light crosstalk from the misalignment will be severe. The need for a low birefringent FEA element drives small and thin lenslet element design. A small lenslet element drives the need for a monolithic FEA fabrication for maintaining the required alignment precision. A thin lenslet substrate ensures little birefringence for the same amount of stressed induced in the substrates.

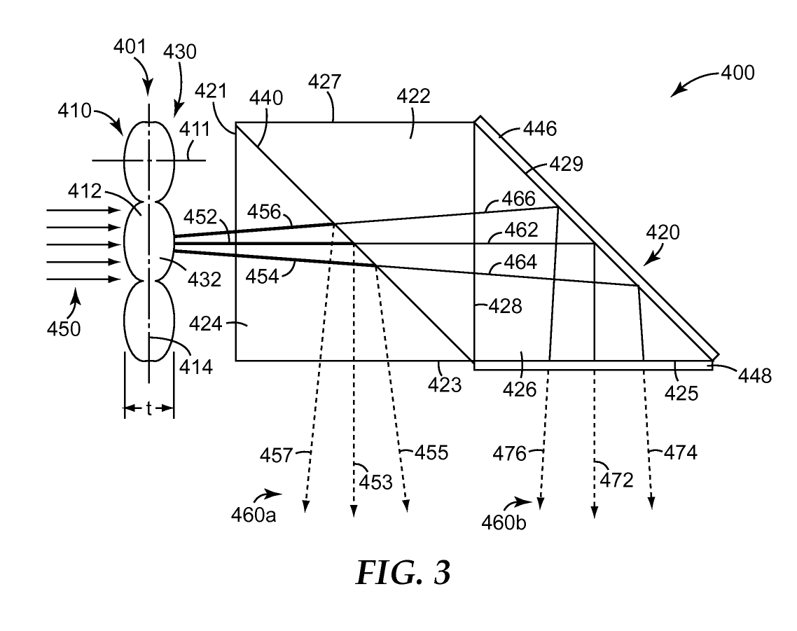

FIG. 3 shows a side-view schematic of an optical element 400, according to one aspect of the disclosure. Optical element 400 can be used as the homogenizing polarization converter module 130 in the image projector 100 as shown in FIG. 1. Optical element 400 includes a polarization converter 420, a first lenslet array 410, and a second lenslet array 430. Each of the first lenslet array 410 and the second lenslet array 430 can be referred to as a “Fly-Eye Array”, or FEA, as known in the art. The first lenslet array 410 and the second lenslet array 430 together form a monolithic FEA 401 that has a thickness “t”, and can include an optional central substrate 414 between first lenslet array 410 and second lenslet array 430.

Each of the elements 410-446 shown in FIG. 3 correspond to like-numbered elements 210-246 shown in FIG. 2, which have been described previously. For example, third prism 426 of FIG. 3 corresponds to third prism 226 of FIG. 2, and so on. In FIG. 3, the relative position of reflective polarizer 440 has changed from the position of reflective polarizer 240 in FIG. 2, and as a result, the path length of each component of the unpolarized input light 450 is different in the configuration shown in FIG. 3, as can be seen in the figure. Generally, the path lengths of each polarization component are preferably the same; however, the optical element 400 will function as an alternate embodiment of a homogenizing polarization converter.

Unpolarized light rays 450 coincident with the first optical axis 411 of the first lens 412 passes through monolithic FEA 401, becomes first divergent unpolarized light ray 452, enters polarization converter 420 through third prism face 421 of second prism 424, and intercepts reflective polarizer 440 where it is split into first p-polarized divergent light ray 462 and first s-polarized divergent light ray 453. In a similar manner, another of the unpolarized light rays 450 entering first lens 412 at a position separated from the first optical axis 411 passes through monolithic FEA 401, becomes second divergent unpolarized light ray 454, and is split into second p-polarized divergent light ray 464 and second s-polarized divergent light ray 455. In yet another similar manner, another of the unpolarized light rays 450 entering first lens 412 at a second position separated from the first optical axis 411 passes through monolithic FEA 401, becomes third convergent unpolarized light ray 456, and is split into third p-polarized divergent light ray 466 and third s-polarized divergent light ray 457.

First, second, and third p-polarized divergent light rays 462, 464, 466 pass through reflective polarizer 440, reflect from broadband mirror 446, and exit polarization converter 420 through fifth prism face 425 of third prism 426, pass through half-wave retarder 448 and become fourth, fifth, and sixth s-polarized divergent light rays 472, 474, 476, collectively second s-polarized divergent light 460b.

First, second, and third s-polarized divergent light rays 453, 455, 457 reflect from reflective polarizer 440, exit second prism through fourth prism face 427, and become first s-polarized divergent light 460a. First and second s-polarized divergent light 460a and 460b pass through the remaining portions of the projection system described in FIG. 1, with an improved uniformity.

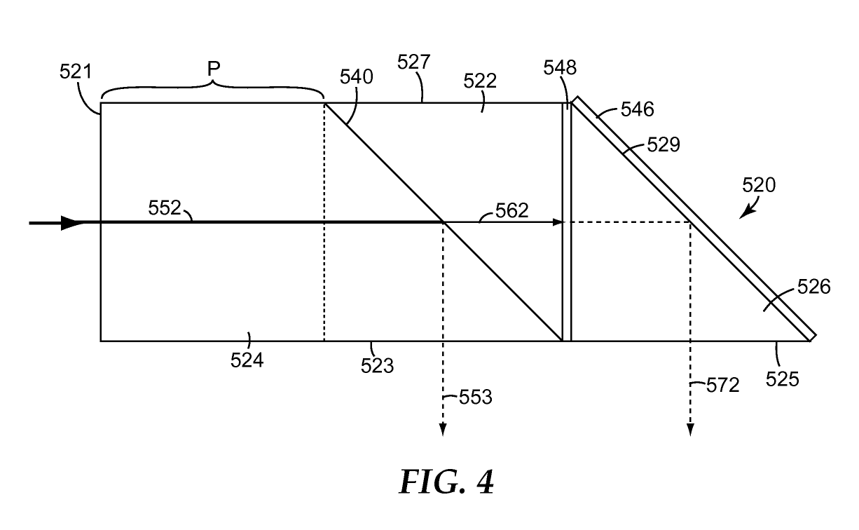

FIG. 4 shows a cross-section schematic of a polarization converter 520 according to one particular embodiment of the disclosure. Polarization converter 520 can be used in place of any of the already described polarization converters, for example, polarization converter 220 in optical element 200 and polarization converter 420 in optical element 400. For brevity, the lenslet arrays have been removed from FIG. 4, and only the path of light through the polarization converter 520 will be described. It is to be understood, however, that the polarization converter module 130 of FIG. 1 includes polarization converter 520 and any associated lenslet array, similar to those described in FIGS. 2-3.

Each of the elements 520-546 shown in FIG. 4 correspond to like-numbered elements 220-246 shown in FIG. 2, which have been described previously. For example, third prism 526 of FIG. 4 corresponds to third prism 226 of FIG. 2, and so on. In FIG. 4, the relative position of reflective polarizer 540 has changed from the position of reflective polarizer 240 in FIG. 2, and as a result, the path length of each component of the unpolarized input light 552 is different in the configuration shown in FIG. 4, as can be seen in the figure. Generally, the path lengths of each polarization component are preferably the same; however, the polarization converter 520 will function as an alternate embodiment of a homogenizing polarization converter.

In one particular embodiment shown in FIG. 4, the second prism 524 has an optional elongated portion “P” extending the length of prism face 523. The extended length of prism face 523 can serve to increase the path length of the unpolarized input light 552, and as a result, the homogenization of the unpolarized input light 552 as described, for example, in co-pending U.S. Patent Application No. 61/292,574, entitled “Compact Optical Integrator” (Attorney Docket No. 65902US002) filed on Jan. 6, 2010.

In one particular embodiment, the polarization converter 520 includes a half-wave retarder 548 disposed between first prism 522 and third prism 526 as shown in FIG. 4. In one particular embodiment, the half-wave retarder 548 can instead be disposed adjacent the prism face 525, in a manner similar to the half-wave retarder 448 shown in FIG. 3. In some cases, the half-wave retarder can be placed anywhere within the optical path of the light transmitted through the reflective polarizer 540, such that the polarization state of the transmitted light is changed to the polarization state of the reflected light. In one particular embodiment, the half-wave retarder can be inserted adjacent to any of the prism faces 523, 540, 548, 525, and 529.

Central unpolarized light beam 552 enters first prism face 521 and intercepts reflective polarizer 540 where it is split into transmitted p-polarized light beam 562 and reflected first s-polarized light beam 553. Reflected first s-polarized light beam 553 then exits polarization converter 520 through second prism face 523. Transmitted p-polarized light beam 562 exits second prism 522, passes through half-wave retarder 548 changing to second s-polarized light beam 572, reflects from broadband reflector 546, and exits polarization converter 520 through fifth prism face 525.

Unless otherwise indicated, all numbers expressing feature sizes, amounts, and physical properties used in the specification and claims are to be understood as being modified by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

All references and publications cited herein are expressly incorporated herein by reference in their entirety into this disclosure, except to the extent they may directly contradict this disclosure. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. An optical element, comprising:
a first lenslet array having a first plurality of lenses disposed to accept an unpolarized light and output a convergent unpolarized light;
a second lenslet array having a second plurality of lenses disposed to accept the convergent unpolarized light and output a divergent unpolarized light; and
a polarization converter disposed to accept the divergent unpolarized light and output a polarized light,
wherein the first lenslet array and the second lenslet array are a monolithic array, and an unpolarized light ray coincident with the optical axis of a first lens of the first plurality of lenses is coincident with the optical axis of a second lens of the second plurality of lenses.

2. The optical element of claim 1, wherein the monolithic array comprises a glass, a polymer, or a silicone.

3. The optical element of claim 1, wherein the monolithic array comprises a polymeric material having a birefringence of less than about 50 nm at a nominal wavelength of 550 nm.

4. The optical element of claim 1, wherein the unpolarized light ray is split into a first polarized light ray and a second polarized light ray having equal optical path lengths through the polarization converter.

5. The optical element of claim 1, wherein the monolithic array has a thickness between about 2 mm and about 10 mm.

6. The optical element of claim 1, wherein the focal point of each of the first plurality of lenses is positioned at a first principle plane of the second plurality of lenses.

7. The optical element of claim 1, wherein the monolithic array further comprises a polymer film disposed between the first plurality of lenses and the second plurality of lenses.

8. The optical element of claim 1, wherein the first plurality of lenses and the second plurality of lenses have a one-to-one correspondence.

9. The optical element of claim 1, wherein at least one of the first plurality of lenses and the second plurality of lenses comprise cylindrical lenses.

10. The optical element of claim 1, wherein at least one of the first plurality of lenses and the second plurality of lenses comprise bi-convex lenses, spherical lenses, or aspherical lenses.

11. The optical element of claim 1, wherein each of the first plurality of lenses and each of the second plurality of lenses have a positive power.

12. The optical element of claim 1, wherein the polarization converter comprises a polarizing beam splitter (PBS) and a polarization rotator.

13. The optical element of claim 12, wherein the PBS comprises a MacNeille polarizer, an array of MacNeille polarizers, a wire grid polarizer, an s-polarization reflective polarizer, or a p-polarization reflective polarizer.

14. The optical element of claim 12, wherein the polarization rotator comprises a quarter-wave retarder, a half-wave retarder, a liquid crystal, or a liquid crystal polymer.

15. The optical element of claim 12, further comprising a broadband reflector.

16. The optical element of claim 15, wherein the broadband reflector comprises a prism having a total internal reflection (TIR) surface.

17. The optical element of claim 15, wherein the broadband reflector comprises a mirror.

18. A light projector, comprising:
a first unpolarized light source and a second unpolarized light source;
a color combiner disposed to output a combined unpolarized light from the first unpolarized light source and the second unpolarized light source;
an optical element, comprising:
a first lenslet array having a first plurality of lenses disposed to accept the combined unpolarized light and output a convergent unpolarized light;
a second lenslet array having a second plurality of lenses disposed to accept the convergent unpolarized light and output a divergent unpolarized light; and
a polarization converter disposed to accept the divergent unpolarized light and output a polarized light,
wherein the first lenslet array and the second lenslet array are a monolithic array, and an unpolarized light ray coincident with the optical axis of a first lens of the first plurality of lenses is coincident with the optical axis of a second lens of the second plurality of lenses.

19. An image projector, comprising:
a first unpolarized light source and a second unpolarized light source;
a color combiner disposed to output a combined unpolarized light from the first unpolarized light source and the second unpolarized light source;
an optical element, comprising:
a first lenslet array having a first plurality of lenses disposed to accept the combined unpolarized light and output a convergent unpolarized light;
a second lenslet array having a second plurality of lenses disposed to accept the convergent unpolarized light and output a divergent unpolarized light;
a polarization converter disposed to accept the divergent unpolarized light and output a polarized light;
wherein the first lenslet array and the second lenslet array are a monolithic array, and an unpolarized light ray coincident with the optical axis of a first lens of the first plurality of lenses is coincident with the optical axis of a second lens of the second plurality of lenses;
a spatial light modulator disposed to impart an image to the polarized light; and
projection optics.

20. The image projector of claim 19, wherein the spatial light modulator comprises a liquid crystal on silicon (LCoS) imager or a transmissive liquid crystal display (LCD).

21. (canceled)
